(19) United States
(12) Patent Application Publication
(10) Pub. No.: US 2002/0029503 A1
(43) Pub. Date: Mar. 14, 2002

(54) Luminous cup pad with amusement function

(76) Inventor: Man Kuen Lam, North Point (HK)

Correspondence Address: RABIN & CHAMPAGNE, PC, 1101 14TH STREET, NW, SUITE 500, WASHINGTON, DC, 20005, US

(21) Appl. No.: 09/754,306

(22) Filed: Jan. 5, 2001

(30) Foreign Application Priority Data
Aug. 8, 2000 (CN) 00242751.6

(51) Int. Cl. G09F 13/22

(52) U.S. Cl. 40/544

(57) ABSTRACT

A luminous cup pad with amusement function is characterized in that it comprises a pad plate, a transparent shell and a base plate, the base plate has a cell box for placing cells, is fitted with horn, and switch, multiple light-emitting diodes and their corresponding driving circuit are fitted at the periphery of the transparent shell, the luminous cup pad will not only enhance the cup pad with a sense of beauty, but also provide people with choice of various functions, and may bring about moving sense of brilliance, static sense of pleasing to both the eye and the mind and rhythmic sense of music; and may also be played as a game fulling of joy.

The present utility model relates to cup pad, particularly to a luminous cup pad with amusement function.

In the past, in the places like dining-halls, dancing halls, night clubs, bars and restaurants, a pad is usually used to protect the table surface against sorching hot cup body. We call it a cup pad. Generally speaking, such a cup pad is of all kinds, but basically it is stationary. To satisfy people's demand for beauty, some cup pads are made with various designs and colors, however, there are certain kinds of imperfection.

The purpose of the present utility is to provide a luminous cup pad with amusement function for increasing amusement atmosphere in dining-halls, dancing halls, night clubs, bars and restaurants, even in home environment. It not only enhances the cup pad with a sense of beauty, but also provides people with choice of various functions. It may bring about moving sense of brilliance, static sense of pleasing to both the eye and the mind, and rhythmic sense of music and may also be played as a game, which can serve as a very good embellishment of environment atmosphere fulling of vitality.

The present utility model is realized as follows. A luminous cup pad with amusement function characterized in that it consists of a pad plate, a transparent shell and a base plate jointed with each other from top to bottom, the inner periphery of said transparent shell is fitted with multiple light-emitting diodes and corresponding driving circuit, said base plate has a cell box for placing cells.

The pad plate has protruding rim with four positioning buckles with hooklet evenly and symmetrically distributed thereon; the inner periphery of the transparent shell is provided with multiple evenly distributed sleeve holes for placing light-emitting diodes, and also has four square pillars with hollows (square hole) symmetrically distributed and cross-shaped leaf spring type contact switches fitted misplacement with the pillars; in the middle of the base plate, there is a cell box for placing cells, waterproof square trap slot, screw hole, square hole, horn window and switch hole; a square waterproof washer is pressed into the waterproof square trap slot, with screw twisted into the screw hole of base plate through a screw hole of cell cover, making up a cell box having certain waterproof ability.

The positioning buckles of the pad plate are inserted into the square holes of pillars of the transparent shell, and a detachable buckle connection is formed by the hoolklets of the positioning buckles with [symbol] -shaped rims in the square holes. The pillars are inserted into the square holes of the base plate, and the pillars and base plate are connected by their close fit.

The basic profile of the transparent shell is a round platform in shape; the bottom edge is rim of waves, corresponding to the wavecrest of the rim of waves, there are provided sleeve holes of multiple light-emitting diodes evenly in distance.

The transparent shell may have various shapes, such as square, rectangle, circle, all being feasible, the rim can also be made with various decorations to enhance a sense of beauty and give enjoyment of beauty to people. For instance the basic profile of the transparent shell is a round platform in shape, with its bottom edge being a beautified rim of waves, sleeve holes for a series of lighting-emitting diodes for placing light-emitting diode are provided evenly in distance corresponding to the wavecrest of the rim of waves, which is also a good design. At the position corresponding to each light-emitting diode, there is a symbolic pattern on the pad plate.

The driving circuit of the light-emitting diode mainly comprises a timing circuit composed of integrated circuit 555; a game oscillating double flash circuit composed of integrated circuit CT112; a music, sound driving circuit composed of transistor Q1; and a functional transforming circuit composed of transforming switch (SW2), triode Q2 and Q3. The emitting light color of the light-emitting diodes can be chosen at random to arrange in pairs.

A further description to the present utility model in combination with an embodiment and its drawings is made as follows.

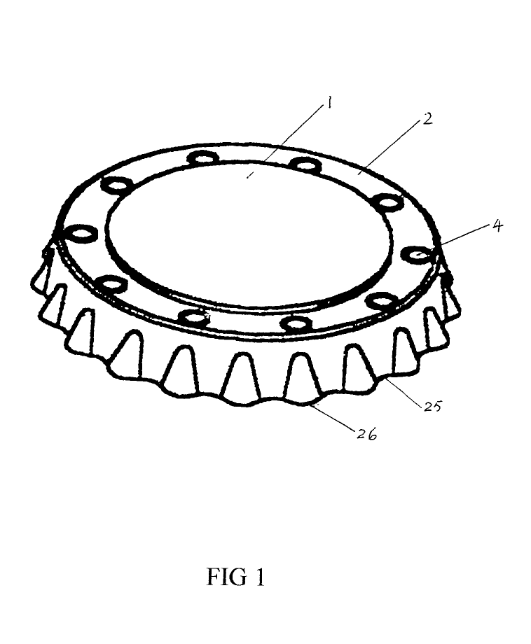

FIG. 1 is a schematic view of a preferred embodiment of luminous cup pad with amusement function for the present utility model.

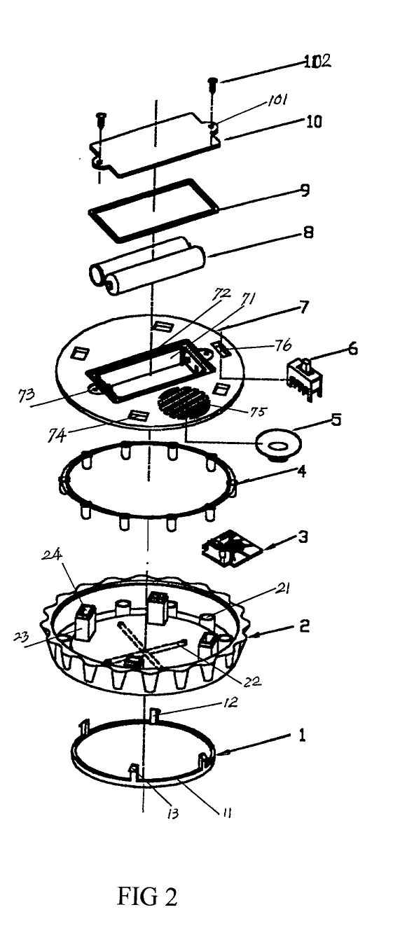

FIG. 2 is an exploded schematic view of the embodiment in FIG. 1.

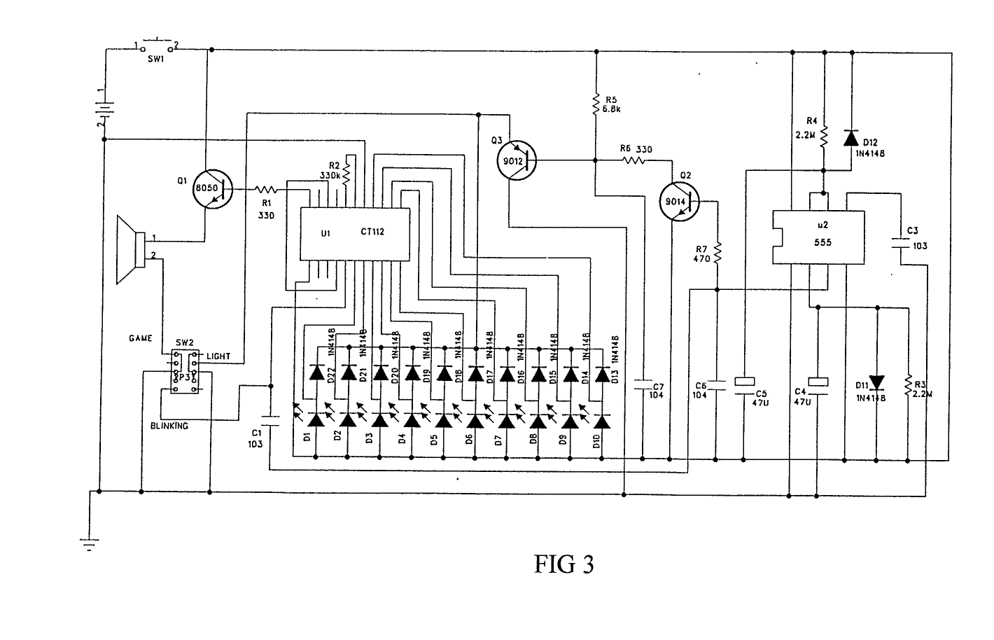

FIG. 3 is a circuit diagram of the embodiment in FIG. 1.

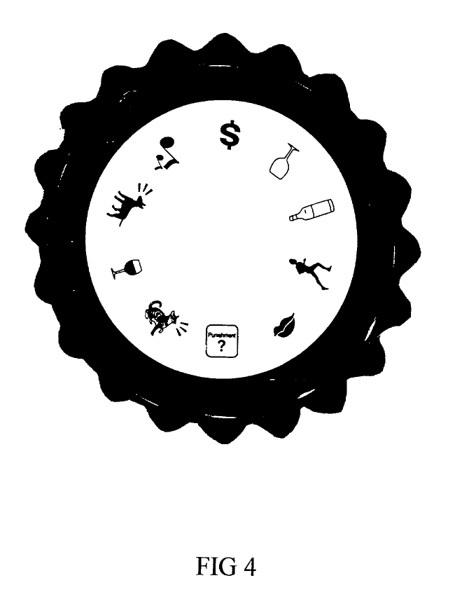

FIG. 4 is one of the figures on the pad plate 1 of the present utility model corresponding to the position of light-emitting diode.

Please refer to FIG. 1, FIG. 2, FIG. 3 and FIG. 4. The luminous cup pad with amusement function mainly comprises pad plate 1, transparent shell 2 and multiple light-emitting diodes 4 fitted at its inner periphery and corresponding driving circuit of the light-emitting diode and base plate 7; in more detail, the pad plate 1 has a protruding rim 11, four positioning buckles 12 with hooklets 13 are evenly and symmetrically distributed thereon, the basic profile of the transparent shell 2 is a round platform in shape with its bottom edge being a rim of wave 25, corresponding to the wavecrest 26 of the rim of wave 25 there is fitted with a sleeve hole 21 of multiple, e.g. 10, light-emitting diodes therein; every peripheral sleeve hole 21 is fitted with a light-emitting diode 4, the color of light-emitting diodes 4 can be chosen according to the design. The transparent shell 2 also has square pillars 23 with hollow (square hole 24) symmetrically distributed and cross-shapes leaf spring type contact switch 22 fitted misplacement with the pillars, the middle of the transparent shell is empty, so as to hold cell box 71, switch 6, horn 5, program control block 3, light-emitting diode and driving circuit, etc. Horn 5 is placed near the horn windows 75, switch (SW2) 6 is placed into hole 76.

In the middle of the base plate 7, there is a cell box 71 for placing cells 8 therein, waterproof square trap slot 72, screw hole 73 and square hole 74; a square waterproof washer 9 being pressed into waterproof square trap slot 72 and with a screw 102 twisted into the screw hole 73 of base plate 7 through a screw hole 101 of cell cover 10, the cell box 41 having certain waterproof ability is thus formed.

The positioning buckles 12 of the pad plate 1 are inserted into the square holes 24 of pillars 23 of the transparent shell 2, the hooklets 13 of positioning buckles 12 form a detachable, moveable connection with [symbol] -shaped rim in the square holes 24, the said pillars 23 are inserted into square holes 74 of the base plate 7 and the pillars and the base plate are connected by their close fit.

The driving circuit of the light-emitting diodes 3 is shown in FIG. 3, it mainly comprises a timing circuit U₂ composed of integrated circuit 555, a game oscillating double flash circuit composed of integrated circuit CT112; a music, sound driving circuit composed of transistor Q1; and a functional transforming circuit composed of transforming switch (SW2), triode Q2 and Q3. The parameters of other elements are also shown in FIG. 3, unnecessary herein further described in details.

As shown in FIG. 4, at every position of the pad plate 1 corresponding to each light-emitting diode, there is a different pattern.

The working principles of the present utility model are as follows.

1. When the switch 6 (SW2) on the base plate 1 is set on GAME, the cup press the pad plate 1 to force the cross leaf spring contact switch (SW1) on. The output terminal “3” of the integrated circuit (IC) U2 “555” outputs high electrical level, making Q2 (9014) and Q3 (9012) turn on, at the same time, diodes D1 D2, D3, D4, D5, D6, D7, D8, D9, D10, D13 forward turn on, keeping each light-emitting diodes turn on and emit light. In the meantime, the IC U2 “555” enters delay status, the delay time is determined by resistor R3, capacitor C4. About one to a few minutes later, the output terminal “3” of the IC U2 “555” jumps from high electrical level to low electrical level, making Q1, Q3 cut-off. At the same time, the outport terminal “3” of the IC U2 “555” jumps from high electrical level to low electrical level, producing a trigger pulse that set U1 “CT112” to work via C1 103, therefor producing oscillation and scanning, so that each light-emitting diode produces flash rotation, and finally remain at the position of a light-emitting diode LED. At the same time, the U1 output terminal “22” outputs music, which is then amplified by the Q1(8050) to drive the horn.

2. When the SW2 switch sets on LIGHT and the pad plate 1 forces the leaf spring contact switch SW1 on, the positive power supply through a series of diodes to negative power supply by SW2, at this time each light-emitting diode emits light and long bright, not influenced by U1,U2.

3. When the SW2 switch sets on BLINKING, if SW1 switched on, the input terminal “4” of the U1 “CT112” is of low electrical level, the output of the U1 “CT112” turns to continuous flash rotation. At the same time, the output circuit of the horn is cut-off, and no sound is produced.

The luminous cup pad with amusement function increased entertainment atmosphere for people in dining-halls, dancing halls, night clubs, bars and even home environment. It can use light-emitting diodes with different colors, provide choice of multiple functions, and realize moving sense and static sense of the light, and rhythmic sense of music.

1. When the base plate SW2 switch sets on GAME, if the cup is touched slightly on movable pad once, after timing circuit delays a few seconds to minutes, the light-emitting diode is turned from long bright to fast flash rotation, and accompanied with music. Along with rotation, the speed is turned from fast rotation to slow rotation. Finally, it remains at positions of any patterns. Touching on movable pad slightly every time, the pattern's position of the light-emitting diode remained finally is not necessarily the same. Indeed, this function is able to bring about full of joy for people in rhythm of music.

2. When the SW2 switch sets on LIGHT, the cup presses the movable pad, the light-emitting diodes turn to be long bright. It lights up all the pad, and may set off all around the cup body with a tender and quite specific color-light, and brought a feeling of pleasing to both the eye and the mind for people.

3. When the SW2 switch sets on BLINKING, the cup presses the movable pad, the light-emitting diodes turn to be flash rotation, producing a non-stop moving light forever, and bring about a jumping and light sense fulling of vitality.

1. A luminous cup pad with amusement function characterized in that it comprises a pad plate 1, a transparent shell 2 and a base plate 7 joined with each other from top to bottom, the inner periphery of the transparent shell 2 is fitted with multiple light-emitting diodes 4 and their corresponding driving circuit, and the base plate 7 has a cell box 71 for placing cells 8.

2. The luminous cup pad with amusement function according to claim 1, wherein the pad plate 1 has a protruding rim 11, on which four positioning buckles 12 with hooklet 13 are distributed evenly and symmetrically;
the inner periphery of the transparent shell 2 is provided with multiple evenly distributed sleeve holes 21 for placing light-emitting diodes, it also has four square pillars 23 with hollow (square hole 24) symmetrically distributed and cross-shaped leaf spring type contact switches 22 fitted misplacement with the pillars;
there is a cell box 71 for placing cells 8 in the middle of the base plate 7, a waterproof square trap slot 72, a screw hole 73, a square hole 74, a horn window 75, and a switch hole 76, a square waterproof washer 9 is pressed into the waterproof square trap slot 72 with a screw 102 twisted into the screw hole 73 of the base plate 7 through a screw hole 101 of the cell cover 10, making up a cell box 41 having certain waterproof ability;
the positioning buckles 12 of the pad plate 1 are inserted into the square holes 24 of the pillars 23 of the transparent shell 2, the hooklets 13 of the positioning buckles 12 form a detachable buckle connection with [symbol] -shaped rim in the square holes 24, the pillars 23 are inserted into the square holes 74 of the base plate7, and the pillars and the base plate are connected by their close fit.

3. The luminous cup pad with amusement function according to claim 1, wherein the basic profile of the transparent shell is a round platform in shape, the bottom edge is a rim of wave 25, corresponding to the wavecrest 26 of the rim of waves 25, there are provided sleeve holes 21 of multiple light-emitting diodes evenly in distance.

4. The luminous cup pad with amusement function according to claim 1, wherein at the position corresponding to every light-emitting diode, there is a symbolic pattern 14 on the pad plate 1.

5. The luminous cup pad with amusement function according to claim 1, wherein the driving circuit of the light emitting diodes mainly comprises a timig circuit composed of integrated circuit 555, a game oscillating double flash circuit composed of integrated circuit CT112, a music, sound driving circuit composed of transistor Q1, and a functional transforming circuit composed of transforming switch (SW2), triode Q2 and Q3.

6. The luminous cup pad with amusement function according to claim 2, wherein the driving circuit of the light emitting diodes mainly comprises a timig circuit composed of integrated circuit 555, a game oscillating double flash circuit composed of integrated circuit CT112, a music, sound driving circuit composed of transistor Q1, and a functional transforming circuit composed of transforming switch (SW2), triode Q2 and Q3.

7. The luminous cup pad with amusement function according to claim 3, wherein the driving circuit of the light emitting diodes mainly comprises a timig circuit composed of integrated circuit 555, a game oscillating double flash circuit composed of integrated circuit CT112, a music, sound driving circuit composed of transistor Q1, and a functional transforming circuit composed of transforming switch (SW2), triode Q2 and Q3.

8. The luminous cup pad with amusement function according to claim 4, wherein the driving circuit of the light emitting diodes mainly comprises a timig circuit composed of integrated circuit 555, a game oscillating double flash circuit composed of integrated circuit CT112, a music, sound driving circuit composed of transistor Q1, and a functional transforming circuit composed of transforming switch (SW2), triode Q2 and Q3.
